(19) United States
(12) Patent Application Publication
(10) Pub. No.: US 2018/0077620 A1
(43) Pub. Date: Mar. 15, 2018

(54) SEAMLESS HANDOVER BETWEEN DEVICES

(71) Applicant: Microsoft Technology Licensing, LLC, Redmond, WA (US)

(72) Inventor: Amer Hassan, Kirkland, WA (US)

(73) Assignee: Microsoft Technology Licensing, LLC, Redmond, WA (US)

(21) Appl. No.: 15/264,886

(22) Filed: Sep. 14, 2016

(51) Int. Cl. H04W 36/18; H04L 29/12; H04W 76/02

(52) U.S. Cl. CPC H04W 36/18; H04W 84/12; H04W 76/021; H04L 61/6022

(57) ABSTRACT

A method and apparatus in a wireless network that allows a first device and second device to perform handover of a session, between the first device and a third device, to the second device is disclosed. The first device and the second device exchange information to enable the handover of the session from the first device to the second device. The second device may then continue the session by communicating with the third device in place of the first device. The handover of the session may be triggered by a user of the first device, triggered by a user of the second device, or automatically initiated upon the occurrence of certain other trigger events. The first and second devices may be devices such as first and second mobile devices operating in a WLAN. The third device may be an access point device of the WLAN.

### BACKGROUND

Wireless local area networks (WLANS) that allow devices to communicate with systems and other devices configured to support businesses, schools, public/private organizations, or homes, etc., have proliferated. For example, Wi-Fi networks that operate using unlicensed 2.4 GHz or 5 GHz frequency bands am now used by almost all businesses and public/private organizations as WLANS.

A user of a WLAN may use multiple devices to access the network. For example, depending on service needs or particular use case, a user may initiate a session to access WLAN services using a smartphone a tablet device, a media device, or a laptop computer. The user may also be involved in sessions that are initiated from the network side to one of the user's devices. These devices with which the user may be in a session with a WLAN may have different capabilities such as video display quality, processing power, sound quality, or battery life. In certain situations, the user may find themselves in a session using one device when they may prefer to use mother one of their devices, or use another device belonging to someone else.

### SUMMARY

This summary is provided to introduce a selection of concepts in a simplified form that are further described below in the Detailed Description. This summary is not intended to exclusively or exhaustively identify key features or essential features of the claimed subject matter. Nor is it intended as an aid in determining the scope of the claimed subject mart.

Embodiments of the disclosure provide a method and apparatus in a wireless network that allows a first device to handover a session, where the session is between the first device and a third device, from the first device to a second device. During the handover, the first device and the second device exchange information to enable the handover of the session from the first device to the second device. After the handover is performed, the second device may continue the session by communicating with the third device in place of the first device. The handover between the first device and second device is transparent to the third device. In embodiments, the handover of the session may be triggered by a user of the first device, triggered by a user of the second device, or automatically initiated upon the occurrence of certain trigger events.

In one example implementation, the first and second devices may be devices such as first and second mobile devices operating in a WLAN that includes an access point (AP) device. The first mobile device may configure a session with the AP device using a access ID. The access ID may be randomly generated for the session. The first mobile device may then communicate with the AP device in the session, and, in response to determining that a trigger event has occurred, communicate with the second mobile device to hand over the session with the AP device to the second mobile device. The second mobile device may then take over the session with the AP device, with the second mobile device in place of the first mobile device. In the handover, the first mobile device may communicate with the second mobile device by sending handover information including the access ID to the second mobile device. The handover information may also include timing information that indicates timing for use of the access ID at both of the first and second mobile devices during handover. In one example implementation, the session with the AP may be on a Wi-Fi channel, the access ID may be a MAC ID, and the first and second mobile devices may communicate the handover information with one another through a Bluetooth interface, a Wi-Fi Direct interface, or another type of short range interface.

In example implementations the event triggering handover of a session between the first mobile device and the AP device to the second mobile device may include receiving input from a user interface indicating that a handover is to occur. This may include, for example, input received at a user interface of the first mobile device when the user of the first mobile device wants to use the second mobile device in the session in place of the first mobile device. The event triggering the handover may also be automatically detected, for example, a low battery may be detected by a monitoring function at the first mobile device to trigger handover.

The embodiments also include example implementations of an AP device that allows handover of a session, between a first mobile device and the AP device, to a second mobile device that takes the place of the first mobile device in the session with the AP device. The handover is managed by the AP device managing communications received from the first and second mobile devices, and by the first mobile device communicating with the second mobile device during handover. The second mobile device acts in place of the first mobile device after the handover. The management by the AP of the communications received from the first and second mobile devices allows a soft handover. In an example implementation, the first mobile device may configure a session with the AP device using a random access ID. The first mobile device may then communicate with the AP device in the session. In response to determining that a trigger event has occurred, the first mobile device may send a handover control signal including the access ID to the second device and an indication to the AP device that a handover of the session is to occur. The AP device may then allow handover of the session between the AP device and the first mobile device to the second mobile device, by managing communications received from both of the first mobile device and second mobile device while both use the same access ID during the handover. The session with the AP may be on a Wi-Fi channel, the access ID may be a MAC ID, and the first and second mobile devices may communicate the handover information with one another through a Bluetooth interface, a Wi-Fi Direct interface, or another type of short range interface.

In another implementation, the AP may include a dabs of MAC IDs that are designated as MAC IDs for which session handover is permitted to occur. The AP may send a designated MAC ID to the first mobile device when a session is set up. When the first and second mobile devices start the handover, the AP may detect the simultaneous use of the same access ID in transmissions from the first and second mobile devices and determine whether the access ID being used is in the database of MAC IDs. If the MAC ID is in the database, the AP may then allow handover of the session between the AP and the first mobile device to the second mobile device by managing communications received from both of the first and second mobile device while both use that same MAC ID during the handover.

### BRIEF DESCRIPTION OF THE DRAWINGS

FIGS. 1A, 1B, and 1C are diagrams illustrating a session handover by example devices operating according to embodiments of the disclosure;

FIG. 2 is a simplified block diagram showing example portions of example first and second devices used in handover of a session;

FIG. 3A is a flow diagram showing example operations for handover of a session from a first device to a second device;

FIG. 3B is a flow diagram showing further example operations for handover of a session from a first device to a second device;

FIG. 4 is a simplified block diagram showing portions of example first and second devices, and an example access point device that may be used in handover of a session; and,

FIG. 5A is a flow diagram showing example operations for handover of a session from a first device to the second device with access point participation;

FIG. 5B is a flow diagram showing further example operations for handover of a session from a first device to the second device with access point participation;

FIG. 6 is a simplified block diagram showing an example device implemented according to FIG. 2 or FIG. 4; and,

FIG. 7 is a simplified block diagram showing an example access point implemented according to FIG. 4.

### DETAILED DESCRIPTION

The system, method and apparatus will now be described by use of example embodiments. The example embodiments are presented in this disclosure for illustrative purposes, and not intended to be restrictive or limiting on the scope of the disclosure or the claims presented herein.

The technologies and techniques that are described herein provide embodiments of systems, methods and apparatus for seamless and efficient handover of a wireless communication session from a first device to a second device. The solution has use, for example, when a user is involved in a communication session with a network, such as on a video call or streaming media, using a first device connected to an access point (AP). In certain situations, the user may want (or need) to handover and transfer the communication session to a second device. The user may desire to handover the communication session for various reasons. For example, the user may want to conduct the video call or view the media on the second device because the second device may provide better quality media viewing or sound quality. In another example, the first device may have a low battery and be running out of the power needed to continue the session.

Currently, a user of a first device involved in a wireless session (such as a skype call, media viewing, etc.) connected through an AP may not seamlessly handover the session from the first device to a second device without utilizing a third party session control service. These session control services provide session control products with the capability to handover a session from a user's first device to a second device. These services control a session by utilizing code implemented in cloud infrastructure to control the handover of the session from the first device to the second device. The services also require that their code be implemented behind the firewall of the network of the user utilizing the services. Also, the service provider's protocol must be used to communicate between the device and the different nodes throughout the cloud that are involved in the session.

The requirement that the third party service's code be installed and used behind the user's network firewall creates security concerns in the user's network. There are also monetary costs and licensing concerns involved in obtaining and implementing the third party service. Additionally, the need to use the service provider's protocol may create complications in communications between nodes within the cloud session since the service provider's protocol must be used on the communication links.

Use of the disclosed embodiments provides technical advantages in that third party session control services are not needed for session handover. This removes the need to install a third party's code behind a network firewall. It also removes the need to communicate through the cloud using the third party's protocols to control the handover of the session from the first device. The embodiments also pr vide session handover that can conveniently be controlled from devices without requiring complicated modifications to the network.

For example, in an implementation of handover of an AP session associated with an access ID from a first to a second device, each of the first and second devices may be configured with functions for performing the seamless handover. In this implementation, the first and second devices may be configured so initiate and coordinate the handover on their own without the AP being involved. Any two devices may be configured as the first and second devices to participate in handover of a session independent of the network in which the AP is located. No code needs to be installed in the network or at the AP to facilitate the handover capability. The handover may be performed in networks having APs configured to use access IDs, even, for example, if the AP is a single conventional off the shelf AP. A device user may configure the handover capability on their devices and utilize it as needed.

In another example implementation, each of the first and second devices may be configured with functions for performing the seamless handover and the AP may also be configured to participate in the handover. This implementation may simplify the coordination communications needed between the first and second devices and also allow soft handover of the session. In this implementation, the first and second devices may be configured to initiate and coordinate the handover on their own, but may inform the AP that a handover is occurring. The AP may be configured to determine that it may receive communications from the first and second devices using the same access ID at the same time during the handover. The AP may then coordinate the communications so the session is seamlessly handed over at the AP. Again, no code needs to be installed in the network. Network modification only needs to be at the AP level. Also, no services need to be accessed in the cloud to facilitate the handover capability.

In example scenarios, a device user may configure the handover capability on both of their smartphone and laptop. If the user had both devices with them and received a video call on the smartphone through an AP, the use could handover the session to the laptop. The user may initiate the handover at a user interface at either device, for example if the user preferred to use the larger screen on the laptop for the video call. Also, if the user noticed that the smartphone was running out of battery power the user could initiate handover of the video call. The devices could also be configured to recognize that battery power was below a threshold when on a session, and automatically initiate handover of the session to the other device. Additionally, one of the devices could be designated as a preferred device for AP sessions, or certain types of AP sessions (video calls, media streaming, etc.). An appropriate session on another device could then be automatically transferred to the preferred device, if the preferred device moved into a suitable location near the other device.

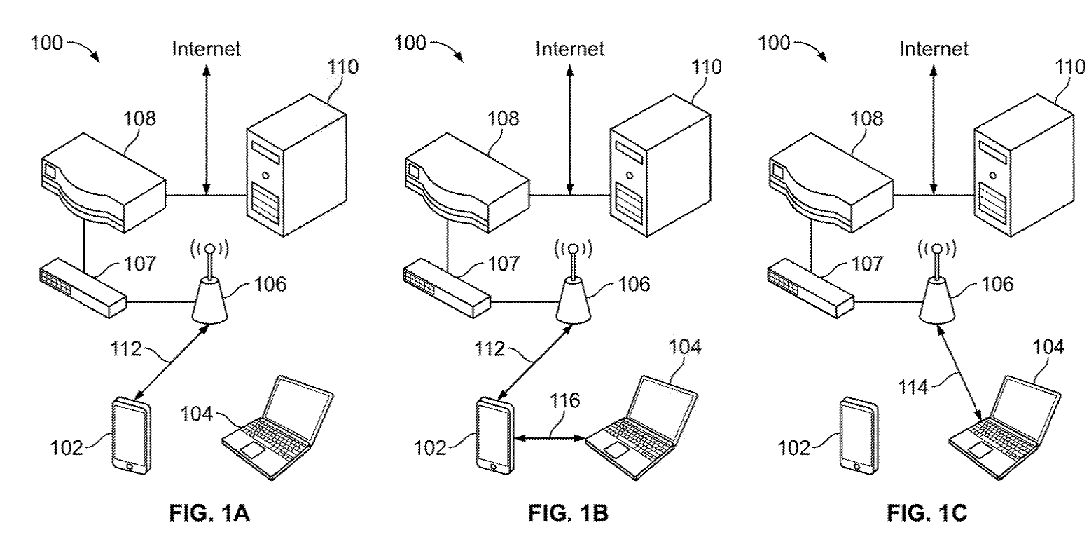

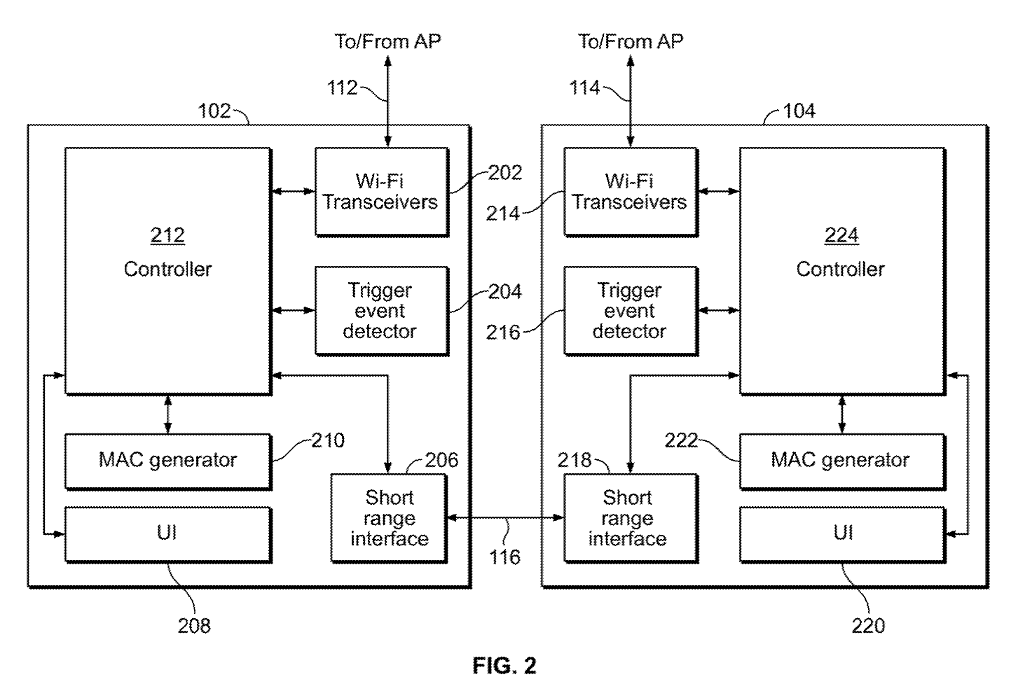

FIGS. 1A, 1B, and 1C are diagrams illustrating a session handover by example devices operating according to embodiments of the disclosure. FIGS. 1A, 1B, and 1C show successive operations performed in handover of a session with access point (AP) 106 from device 102 to device 104, within wireless network 100. FIG. 1A shows device 102 in a session with access point (AP) 106 on wireless link 112, FIG. 2B shows device 102 communicating with device 104 on device-to-device link 116 to initiate handover while still on the session, and FIG. 1C shows device 104 on wireless link 114 in the session after handover takes place.

Wireless network 100, which may be a local area network (WLAN), includes access point (AP) 106, and also may include any number of other APs that are not shown. Network 100 also includes switch 107, gateway 108, and controller 110. Access point (AP) 106, switch 107, gateway 106, and controller 110 may be configured to provide traffic routing and switching functions for traffic to and from the access point 106 over the infrastructure. Devices 102 and 104 are shown operating within the coverage area of network 100. Network 100 may be a private business network, a network implemented for a commercial/retail, or any other type of wireless network. Also, any number of other devices, in addition to devices 102 and 104, may operate in network 100.

While devices 102 and 104 are each shown in FIGS. 1A, 1B, and 1C implemented as an example smart phone and laptop computer, each of the example devices 102 and 104 may be alternatively implemented as any other type of device that may be configured with functionality supporting the embodiments disclosed herein. These other types of devices may include, for example, desktop PCs, gaming devices, media devices, smart televisions, home theater systems, smart automobile systems, smart house systems, multimedia cable/television boxes, smart phone accessory devices, tablet devices, tablet accessory devices, personal digital assistants (PDAs), portable media players, smart watches, smart sensors, or industrial control systems.

In an example implementation, network 100 may comprise a Wi-Fi network that operates over a range of frequencies on communication links according to IEEE 802.11 standards specifications. The frequency range may include frequency bands in the range of 300 MHz to 90 GHz, each according to the 802.11 specification for the particular frequency band. For example, network 100 may include access point (AP) 106, and other APs, that include transceivers operable according to one or more of the 802.11a (5 GHz), 802.11b (2.4 GHz), 802.11g (2.4 GHz), 802.11n (2.4/5 GHz), 802.11 ac (5 GHz), 802.1 lad (60 GHz), 802.11af (54-698 MHz) (TVWS), or 802.11ah (0.9 GHz) (Wi-Fi HaLow) standards. The access points may be capable of communicating on channels of various bandwidths within the frequency ranges according to the standard being used for the communications.

Devices 102 and 104 may each also be operable as a Wi-Fi device to communicate with the network access point 106 according to one or more of the IEEE 802.11 standards specifications on which the access point operates. Devices 102 and 104 may each include one or more applications that communicate data traffic with access point (AP) 106 when in a session with access point (AP) 106. These applications may include any type of application communicating data over network 100, such as client applications communicating with a client application on a device in another network

Devices 102 and 104 may also include one or more applications for communicating over a wireless interface directly with each other using applications such as peer to peer or device to device applications. These applications communicating directly with other devices could include, for example, applications implementing short range interfaces such as Bluetooth, or 802.11 2.4 GHz Wi-Fi Direct for device to device connections.

FIG. 2 is a simplified block diagram showing portions of an example device 102 and an example device 104 used in an implementation for handover of a session. Device 102 includes Wi-F transceivers 202, trigger event detector 204, short range interface 206, user interface (UI) 208, media access control (MAC) generator 210, and controller 212. Device 102 may communicate with access point (AP) 106 over wireless link 112. Device 102 may also communicate with device 104 over short range wireless link 116. Device 104 includes Wi-Fi transceivers 214, trigger event detector 216, short range interface 218, user interface (UI) 220, media access control (MAC) generator 222, and controller 224. Device 104 may communicate with access point (AP) 106 over wireless link 114. Device 104 may also communicate with device 102 over short range wireless link 116.

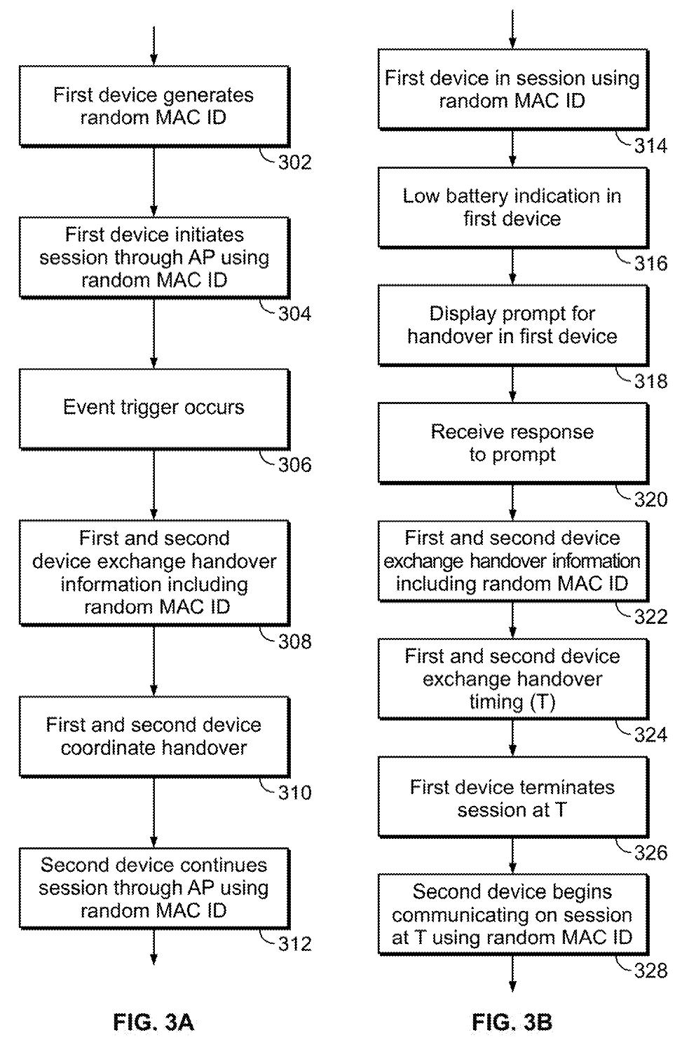

FIG. 3A is a flow diagram showing example operations for handover of a session from a first device to a second device. FIG. 3A may be described with reference to FIGS. 1A, 1B, and 1C, and to FIG. 2, using devices 102 and 104, respectively, as the first and second devices of FIG. 3A.

The process begins at 302 where device 102 generates a random access ID (MAC ID). Controller 212 may use MAC generator function 210 to generate the random MAC ID in device 102. At 304, device 102 initiates a session with access point (AP) 106 using the random MAC ID. Controller 212 may use Wi-Fi transceivers 202 to communicate with access point (AP) 106 over link 112 to initiate the session. In an implementation, controller 212 may use IEEE 802.11 protocols to communicate with access point (AP) 106 to initiate the session. Device 102 may then communicate data with access point (AP) 106. For example, device 102 may participate in a video call, receive streamed media, or communicate my other type of data through access point (AP) 106 using IEEE 802.11 protocols. This is shown in FIG. 1A where device 102 is shown communicating with AP 216 over link 112. The random MAC ID may be used to identify the particular session independently from the identity of device 102. This is because the MAC ID is randomly generated and not tied to the identity of device 102, as would be a device MAC ID.

At 306, trigger event detector 204 in device 102 determines that a trigger event has occurred. The trigger event may be any event that indicates a handover of the session between device 102 and access point (AP) 106 established at 304 should be performed. The trigger event may include controller 212 receiving input at UI 208 requesting that a handover be performed. The trigger event also may include controller 212 automatically detecting a condition such as low battery power in device 102, or detecting through short range interface 206 that another device, such as device 104, that is more suited to the type of data communicated in the session has moved into proximity of device 102. For example, if a user of a smartpbone as device 102 is streaming media or on a call including video, the user may prefer to use the larger display of a laptop as device 104 while viewing the video. This preference may be configured into applications on device 102 and 104 that communicate through short range interfaces 206 and 218 to perform the detection and initiation of handover.

At 308, device 102 and device 104 exchange handover information. In response to the trigger event, device 102 sends the random MAC ID to device 104. Device 102 may include the random MAC ID in handover control signals exchanged by controller 212 of device 102 and controller 224 of device 104 through short range interface 206 and short range interface 218. Device 102 may already have connected to device 104 through short range interface 206, or may connect to device 104 in response to the determination of the trigger event. The handover control signals sent at 308 also may include signals sent to inform device 104 of the handover, an acceptance signal for the handover sent from device 104 to device 102, and other information needed to coordinate the handover. The other information needed to coordinate the handover may include timing information for data transmission during handover, information on any encryption used by controller 212 of device 102 in the session, and any data stored in device 102 that is needed by controller 224 of device 104 to take handover of the session without undue interruption of the data communications taking place in the session. This is shown in FIG. 1B by device 102 and device 104 exchanging the handover control signals over short range link 116 while device 102 communicates data in the session with access point (AP) 106. For example, if device 102 is involved in a video call, the handover control signals may include information about parameters for setup of an application used to conduct the video call. The handover control signals may also include information about parameters for a Wi-Fi protocol used in the session and/or encryption information. The sending of various handover control signal may involve user interaction with UIs 208 or 220 in devices 102 and 104. For example, an acceptance of transfer of the session may be required to be entered at UI 220 of device 104.

At 310, device 102 and device 104 coordinate the handover. The coordination may include sending and receiving data to/from access point (AP) 106 according to the timing information sent in the handover control signals. For example, controller 224 of device 104 may initiate the sending of data to access point (AP) 106 using the random MAC ID according to the timing information. Also, controller 212 of device 102 may terminate the sending of data to access point (AP) 106 using the random MAC ID according to the timing information. The timing may be configured so that device 102 terminates the sending of data immediately before device 104 begins to send data. Controller 224 of device 104 also may begin to use information sent by device 102 related to any encryption in the session, session protocol configurations, session application parameters, etc., that is needed to take handover of the session.

At 312, device 104 continues in place of device 102 in the session with access point (AP) 106. This is shown in FIG. 1C as device 104 communicates with access point (AP) 106 on link 114 and device 102 has stopped sending data to access point (AP) 106. Link 114 may comprise the same radio channel that device 102 used for the session on link 112. The data communications previously performed between device 102 and access point (AP) 106 may now be performed between device 104 and access point (AP) 106. For example, a participant of a video call that had started on the call at device 102 may now continue on the video call using device 104. The access point (AP) 106 may be unaware that the data communications are now with device 104 instead of device 102.

FIG. 3B is a flow diagram showing further example operations for handover of a session from a first device to a second device. FIG. 3B shows an implementation of FIG. 3A that uses interaction with a user of device 102 for handover of a session. The process begins at 314 as device 102 is in an ongoing data communications session with access point (AP) 106 using a random MAC ID that was generated at device 102. At 316, trigger event detector 204 may detect that battery power has fallen below a threshold level needed to maintain ongoing data communications on the session. This threshold may be set at a level that will allow time for session handover after the determination that the battery power is below the threshold. Trigger event detector 204 may then provide a indication of low battery power to controller 212. At 318, controller 212 of device 102 initiates display of a prompt at UI 208 that informs a user of device 102 that a handover is needed to continue the session because the power is below the threshold. The prompt may also request that the user give input regarding a possible handover of the session to another device. For example, the prompt may identify device 104 as a connected device on the short range interface and ask the user if the user wants to handover the session to device 104 by selecting from a list of connected devices.

At 320, input including a response to the prompt is received at device 102 by controller 212 from UI 208. The response may include information indicating that the handover is to occur and indicating also that device 104 is the handover target. At 322, controller 212 of device 102 and controller 224 of device 104 begin the exchange of handover control signals that include the random MAC ID through short range interfaces 206 and 218 over link 116. The handover control signals may also include any encryption information that is needed at device 104 to participate in the ongoing data communications on the session. At 324, controller 110 and controller 224 also exchange handover control signals that include handover timing information through short range interfaces 206 and 218. The handover control information includes information that allows controller 224 to control Wi-Fi transceiver 214 of device 104 to start the sending of data over the session using the random MAC ID at a reference time T. The time T may be set so that controller 212 of device 102 controls Wi-Fi transceiver 202 of device to terminate the sending of data on the session immediately prior to time T. The timing may be set to allow device 104 to receive/intercept enough of the session data sent from access point (AP) 106 to device 102 before taking over the session, so that device 104 can take over the call with as little data lost as possible.

At 326, controller 212 controls Wi-Fi transceiver 202 of device 102 to terminate sending of data in the session immediately prior to the reference time T and leaves the session. At 328, controller 224 controls Wi-Fi transceiver 214 in device 104 to start the sending of data in the session using the random MAC ID at the reference time T. Device 104 then continues the data communications in the session with access point (AP) 106.

In an alternative implementation of FIGS. 3A and/or 3B, the user of the first device may desire to keep at least a portion of the session going on the first device after transferring the session to the second device. For example, the user may desire to keep viewing the video portion of an audio/video session on the larger screen of a first device, such a laptop, after transferring the session to a second device, such as the user's mobile phone. The user may do this, for example, to talk more privately without being forced to use a speaker phone of the laptop if the user is in a public area. In this implementation, the first and second device may be configured so that the first device continues to receive session transmissions from access point (AP) 106 in order to receive and display the video presentation after handover. While the first device continues to receive and display the video, the session may be conducted by the second device communicating with access point (AP) 106, as the second device takes over the session and communicates with access point (AP) 106. In one implementation, at operation 326 of FIG. 3B the first device would terminate transmissions to access point (AP) 106 but still keep receiving transmission using the random MAC ID in order to display the video portion of the session. The second device may keep the first device updated with any information needed to receive the transmission, such as encryption information though short range interface link 116.

Also, in another alternative implementation, the event trigger that triggers the handover of a session from the first device to the second device may be a trigger signal received from a third device, such as another mobile device. The third device may send a trigger signal over a short range interface of the first device to trigger the handover of the session at operation 306. For example, a user of the first device may have application software configured on a third device by which the user may control triggering of session handovers between the first and second device from a user interface of the third device.

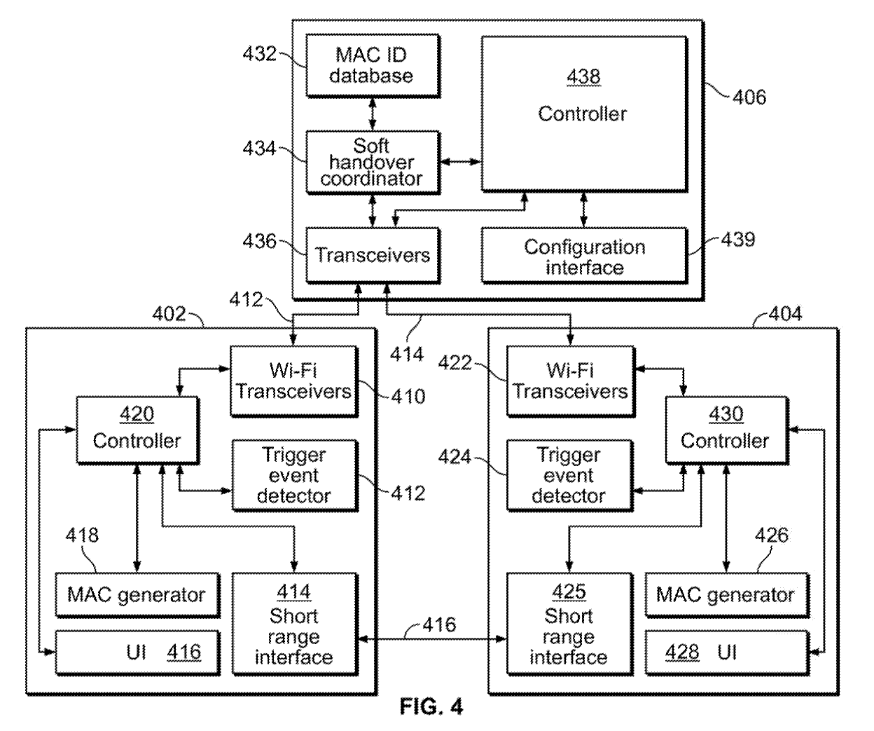

FIG. 4 is a simplified block diagram showing portions of an example device 402, an example device 404, and a example access point (AP) 406, in another implementation for handover of a session. In the example of FIG. 4, access point (AP) 406 communicates with devices 402 and 404 during the handover.

Access point (AP) 406 includes MAC ID database 432, soft handover coordinator 434, Wi-Fi transceivers 436, controller 438, and configuration interface 439. Access point (AP) 406 may communicate with device 402 over wireless link 412 and with device 404 over wireless link 414. Link 412 and link 404 may use the same Wi-Fi frequency channel. Device 402 includes Wi-Fi transceivers 410, trigger event detector 412, short range interface 414, user interface (UI) 416, media access control (MAC) generator 418, and controller 420. Device 402 may communicate with access point (AP) 406 over wireless link 412. Device 402 may also communicate with device 404 over short range wireless link 416. Device 404 includes Wi-Fi transceivers 422, trigger event detector 424, short range interface 425, user interface (UI) 428, media access control (MAC) generator 426, and controller 430. Device 404 may communicate with access point (AP) 406 over wireless link 414. Device 404 may also communicate with device 402 over short range wireless link 416.

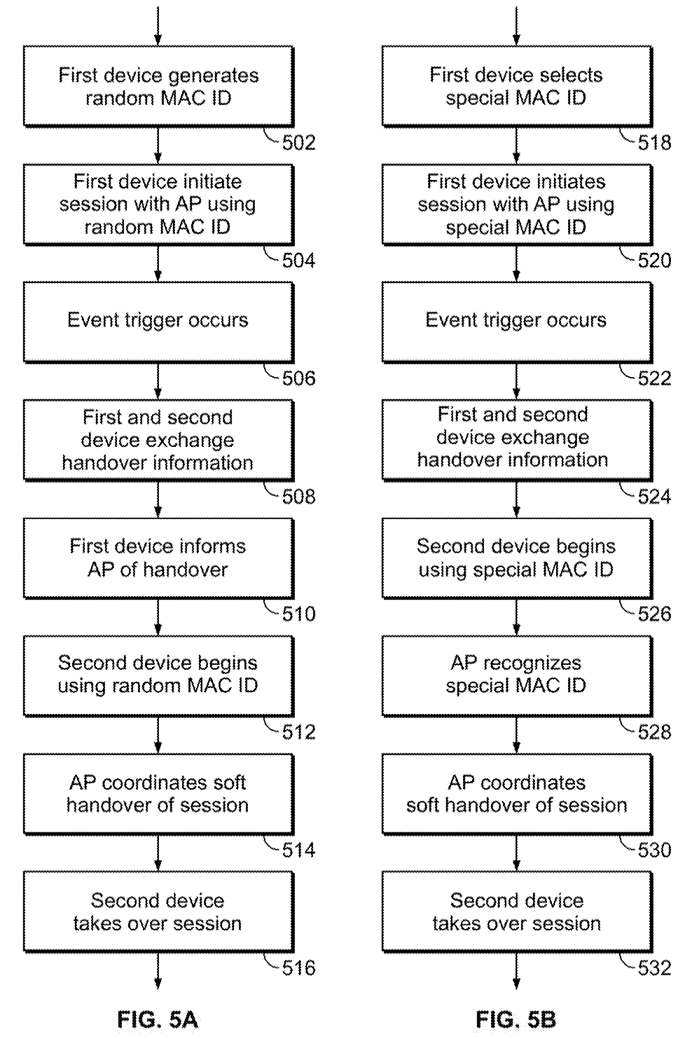

FIG. 5A is a flow diagram showing example operations for handover of a session from a first device to a second device with access point participation. FIGURE SA may be described with reference to FIG. 4, using devices 402 and 404 as, respectively, the first and second devices of FIG. 5A. FIGURE SA may also be described with reference to FIGS. 1A, 1B, and 1C, using devices 402 and 404, and access point (AP) 406, in place of respectively, devices 102 and 104, and access point (AP) 106.

The process begin at 502 where device 402 generates a random access ID (MAC ID). Controller 420 may use MAC generator function 418 to generate the random MAC ID in device 402. At 504, device 402 initiates a session with access point (AP) 406 using the random MAC ID. Controller 420 may use Wi-Fi transceivers 410 to communicate with access point (AP) 406 over link 412 to initiate the session. In an implementation, controller 420 may use IEEE 802.11 protocols to communicate with access point (AP) 406 to initiate the session. Device 402 may then communicate data with access point (AP) 406. For example, device 402 may participate in a video call, receive streamed media, or communicate any other type of data through access point (AP) 406 using IEEE 802.11 protocols. This is shown in FIG. 1A where device 102 (402) is shown communicating with access point (AP) 106 (406) over link 112 (412). The random MAC ID may be used to identify the particular session independently from the identity of device 402. This is because the MAC ID is randomly generated and not tied to the identity of device 402, as would be a device MAC ID.

At 506, trigger event detector 412 in device 402 determines that a trigger event has occurred. The trigger event may be any event that indicates a handover of the session between device 402 and access point (AP) 406 established at 504 should be performed. The trigger event may include controller 420 receiving input at UI 416 requesting that a handover be performed. The trigger event also may include controller 420 automatically detecting a condition such as low battery power in device 402, or detecting through short range interface 414 that another device, such as device 404, that is more suited to the type of data communicated in the session has moved into proximity of device 402. For example, if a user of a smartphone as device 402 is streaming media or on a call including video, the user may prefer to use the larger display of a laptop as device 404 while viewing the video. This preference may be configured into applications on device 402 and 404 that communicate through short range interfaces 414 and 425 to perform the detection and initiation of handover.

At 508, device 402 and device 404 exchange handover information. Device 402 sends handover information including the random MAC ID to device 404. Device 402 may provide the handover information including the random MAC ID in handover control signals exchanged by controller 420 of device 402 and controller 430 of device 404 through short range interfaces 414 and 425. Device 402 may already have connected to device 404 through short rang interface 414, or may connect to device 404 through shot range interface 414 in response to the determination of the trigger event. The handover control signals sent at 508 also may include signals sent to inform device 404 of the handover, an acceptance signal for the handover sent from device 404 to device 402, and other information needed to coordinate the handover. The other information needed to coordinate the handover may include timing information for timing data transmissions from devices 402 and 404 during handover, information on my encryption used by controller 420 of device 402 in the session, and any data stored in device 402 that is needed by controller 430 of device 404 to take handover of the session without undue interruption of the data communications taking place in the session. The other information needed to coordinate the handover may also include configuration parameters for the Wi-Fi protocol on link 412, and configuration parameters for many applications communicating data on link 412. This is shown in FIG. 1B by device 102 (402) and device 104 (404) exchanging the handover control signals over short range link 116 (412) while device 102 (402) communicates data in the session with access point (AP) 106 (406). For example, if device 402 is involved in a video call, the handover control signals may include information about the setup of an application used to conduct the video call and the parameters of the Wi-Fi channel that carries the video call. The sending of various handover control signal may involve user interaction with UIs 416 or 425 in devices 402 and 404. For example, a handover acceptance may need to be sent from device 404 to device 402 before handover may proceed.

At 510, device 402 informs access point (AP) 406 of the handover by sending a handover control signal over link 412 to access point (AP) 406. The handover control signal informs access point (AP) 406 that a handover of the session identified by the random MAC ID generated in device 402 is to take place. Controller 438 of access point (AP) 406 may store the random MAC ID in MAC ID database 432. At 512, device 404 begins receiving and/or sending on link 414 using the random MAC ID on the same Wi-Fi channel as used by device 402, according to the timing information received from device 402.

At 514, controller 438 and soft handover coordinator 434 of access point (AP) 406 coordinate a soft handover of the session as data is received from device 402 and/or device 404 during the handover. The coordination may include managing received data communications identified by the random MAC ID from device 402, then receiving and managing data communications identified by the random MAC ID from both device 402 and device 404 at the same time, and then receiving and managing data communications identified by the random MAC ID from device 404 after device 402 leaves the session. For example, controller 430 of device 404 may initiate the sending of data to access point (AP) 406 and controller 420 of device 402 may initiate the termination of the sending of data to access point (AP) 406 using the random MAC ID according to the timing information. The timing information may be configured so that there is a period of time during the handover when device 402 and device 404 both transmit data to access point (AP) 406 using the MAC ID. Controller 438 and soft handover coordinator 434 of access point (AP) 406 manage the data received from devices 402 and 404 so that the duplicate MAC ID used by both devices 402 and 404 does not cause problems with the data communications in the session during the handover. For example, when receiving data from both of device 402 and 404 identified by duplicate MAC IDs during a certain time period, access point (AP) 406 may discard data from one of the devices. Access point (AP) 406 may also override any security flags raised by the use of duplicate MAC IDs so the session is not terminated for security concerns. Controller 430 in device 404 also may begin to use information sent by device 402 related to any encryption in the session, and any other data sent by device 402 that was stored in device 402 and that is needed to take handover of the session.

At 516, device 404 takes over the session and continues in place of device 402 in the session with access point (AP) 406 as device 402 terminates sending and receiving of data on the session. This is shown in FIG. 1C a device 104 (404) communicates with access point (AP) 106 (406) on link 114 (414) and device 102 (402) has stopped sending data to access point (AP) 106 (406). Link 114 may comprise the same radio channel that device 402 used for link 112. The data communications previously performed between device 402 and access point (AP) 406 may now be performed between device 404 and access point (AP) 406. For example, a participant of a video call that had started on the video call at device 402 may now continue on the video call using device 404.

FIG. 5B is a flow diagram showing further example operations for handover of a session from a first device to a second device with access point participation. FIG. 5B shows an implementation in which the MAC ID used for the session that is handed over is a “special MAC ID”. The special MAC ID is a MAC ID belonging to a set of one or more special MAC IDS that is known to a first device, such as device 402, and an AP, such as access point (AP) 406, as a MAC ID that may be used in a session handover from the first device to a second device. There may be a set of one or more special MAC IDs for use in a network. Device 402 may use a special MAC ID for sessions, where use of the special MAC ID in a session provides the capability to hand over the session. When access point (AP) 406 detects the use of duplicate MAC IDs by devices 402 and 404 during handover, access point (AP) 406 may check MAC ID database 432 to see if the MAC ID is a special MAC ID that has been pre-stored in MAC ID database 432 for session handover. If the MAC ID is a special MAC ID then access point (AP) 406 can manage the handover appropriately using soft handover techniques. The soft handover techniques may provide a smoother handover of a session as compared to handover where access point (AP) 406 has no knowledge of the handover occurring. For example, access point (AP) 406 may receive duplicate data simultaneously from devices 402 and 404 and coordinate the selection and sequencing of data packets to be sent to a third device/party participating in the session. This may prevent the dropping or the loss of data when handover of the session takes place. If access point (AP) 406 detects the use of duplicate MAC IDs by devices such as devices 402 and 404, and the duplicate MAC ID is not a special MAC ID, access point (AP) 106 may perform a security procedure. For example, access point (AP) 406 may determine that device 406 is attempting to intercept or hijack the session and shut the session with the duplicate MAC ID down. In this aspect, the special MAC ID may perform a security function.

The process of FIGURE SB begins at 518 where device 402 selects a special MAC ID. Device 402 may select the special MAC ID itself from a database in MAC generator 418, or receive the special MAC ID from access point (AP) 406. For example, a set of special MAC IDs may be stored in MAC ID database 432 of access point (AP) 406 and one may be sent to device 402 before or during session setup. In another example, the special MAC ID may be pre-stored, for example, by a device/network manager in a database of MAC generator 418 of device 402 and in MAC ID database 432 of access point (AP) 406. The network manager may use configuration interface 439 of access point (AP) 406 to store a set of special MAC IDs in MAC ID database 432.

At 520, device 402 initiates a session with access point (AP) 406 using the selected special MAC ID. Device 402 and access point (AP) 406 then begin data communication on the session. At 522, a trigger event occurs. Next, at 524, device 402 and device 404 exchange handover information. In response to the trigger event, device 402 sends handover control signals including handover information and the special MAC ID to device 404 over short range interface 416. At 526, device 404 begins using the special MAC ID in communications to access point (AP) 406 according to handover timing information received from device 402. Access point (AP) 406 recognizes that devices 402 and 404 are using duplicate MACs and determines from MAC ID database 432 that the MAC is designated as a special MAC ID. At 530, controller 438 and soft handover coordinator 434 of access point (AP) 406 coordinate a soft handover of the session as data is received from device 402 and/or device 404 during the handover. As access point (AP) 406 receives duplicate data simultaneously from devices 402 and 404 access point (AP) 406 coordinates the selection and sequencing of data packets to be sent to a third device/party participating in the session. This prevents the dropping or the loss of any data when device 402 terminates ending of data and handover of the session takes place. At 532, device 404 takes over the session using the special MAC ID and continues in place of device 402 in the session with access point (AP) 406.

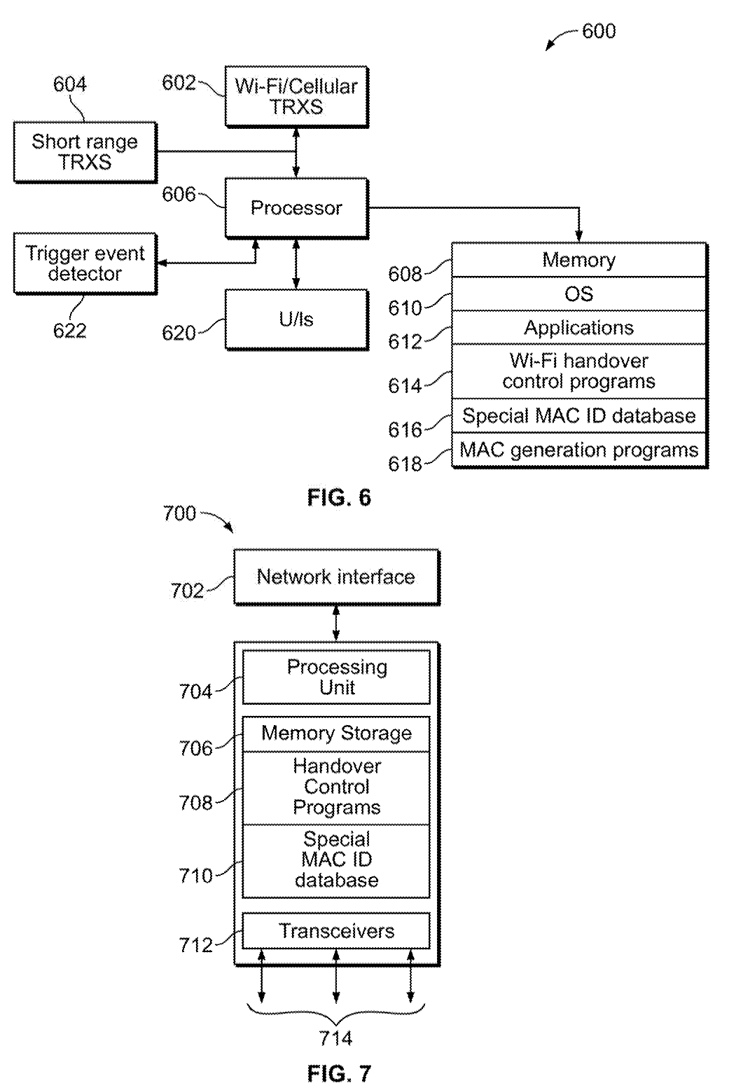

Referring now to FIG. 6, therein is a simplified block diagram of an example mobile device 600 which may be implemented in a network to perform session handover operations. Device 600 represents a possible implementation of either of devices 102 or 104 of FIG. 2, or either of devices 402 or 404 of FIG. 4. Device 600 may include user interface (UI) 620 which may include any type of interface for example, a touch screen/keypad, microphone, speaker or camera which receive inputs and provide outputs to and from device 600. Device 600 also includes short range TRXs 604, event trigger detector 622, processor 606, and memory 608. Short range TRXs 604 allow device 600 to communicate with other devices to perform Wi-Fi session handover. Device 600 also includes Wi-Fi/cellular transceivers (TRX) 602 that operate in different example frequency bands to communicate with Wi-Fi APs. In an implementation, device 600 and its transceivers may be operable to use one or more spectrum allocations that are allowed in each of the designated frequency bands according to my relevant IEEE 802.11 standard specifications.

Event trigger detector 622 detects occurrences of events that trigger handover of a Wi-Fi session. Memory 608 is shown as including program code or instructions for Wi-Fi handover control programs 614 that perform functions according to the embodiments. Execution of Wi-Fi handover control programs 614 causes processor 606 to implement operations that cause device 600 to participate in a Wi-Fi data communication session handover. Device 600 may be configured to act as a device that is handing a session over to another device, or as a device that is receiving handover of a session from another device, depending on the situation.

Memory 608 may also include program code or instructions for MAC generation programs 618, special MAC ID database 616, applications 612, and OS programs 610 in the form of code for running the operating system to control the overall operations of device 600. Processor 606 may comprise one or more processors, or other control circuitry or any combination of processors and control circuitry that provide overall control of device 600 and other functional blocks shown in FIGS. 2 and 4 by implementing instructions and code in memory 608 to provide functions for operation in network 100 according to the disclosed embodiments. Memory 608 may be implemented as any type of computer readable storage media, including non-volatile and volatile memory.

FIG. 7 is a simplified block diagram of an example access point (AP) 700 which may be implemented in a network to perform operations for session handover. For example, access point (AP) 406 of FIG. 4 may be implemented according to FIG. 7. AP 700 includes processing unit 704, transceivers 712, and memory/storage 706 that includes code and instructions for handover control program 708. Memory 706 may be implemented as any type of as any type of computer readable storage media, including non-volatile and volatile memory. In some implementations memory 706 may include code comprising special MAC ID database 710 which may include the identities of a set of special MAC IDs that are used for session handover. AP 700 connects to a backend network over interface 702. Processing unit 704 may comprise one or more processors, or other control circuitry or any combination of processors and control circuitry that provide overall control of AP 700 according to the disclosed embodiments. Transceivers 712 provide the capability for to communicate with devices, such as devices 102 and 104 of FIG. 2, or, devices 402 and 404 of FIG. 4, over channels according to 802.11 protocols.

In the embodiments, execution of Wi-Fi handover control programs 708 causes processing unit 704 to implement operations tat cause AP 700 to perform appropriate operations according to FIGS. 5A-5B to provide session handover for devices such as those operating in network 100.

The example embodiments disclosed herein may be described in the general context of processor-executable code or instructions stored on memory that may comprise one or more computer readable storage media (e.g., tangible non-transitory computer-readable storage media such as memory 608 or 706). As should be readily understood, the terms “computer-readable storage media” or “non-transitory computer-readable media” include the media for storing of data, code and program instructions, such as memory 608 or 706, and do not include portions of the media for storing transitory propagated or modulated data communication signals.

While the functionality disclosed herein has been described by illustrative example using descriptions of the various components and devices of embodiments by referring to functional blocks and processors or processing units, controllers, and memory including instructions and code, the functions and processes of the embodiments may be implemented and performed using any type of processor, circuit, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICs), application specific standard products (ASSPs), system-on-a-chip systems (SOCs), complex programmable logic devices (CPLDs), etc. Use of the term processor or processing unit in this disclosure is mean to include all such implementations.

The disclosed embodiments include a first device comprising one or more processors, and memory in communication with the one or more processors, the memory containing code that, when executed, causes the one or more processors to control the first device to configure a session with a second device using an access ID, determine that a trigger event has occurred, and, initiate, in response to the trigger event occurring, communications with a third device to hand over the session with the second device, from the first device to the third device. The communications initiated with the third device may include sending of the access ID to the third device. The code may be further executable to cause the one or more processors to control the first device to randomly generate the access ID. The code may be further executable to cause the one or more processors to control the first device to receive the access ID from the second device. The first device may configure the session with the second device over a Wi-Fi channel and initiate the communications with the third device over a short range interface. The first device may further comprises a user interface, in communication with the one or more processors, and the first device may determine that the trigger event has occurred by receiving input at the user interface indicating that a handover is to occur. The first device may initiate the communications with the third device to hand over the session with the second device by exchanging information including timing information with the third device, wherein the timing information indicates timing for use of the access ID at both of the first and third device during handover. The access ID may be a Wi-Fi media access control ID.

The disclosed embodiments also include a first device comprising one or more processors, and memory in communication with the one or more processors, the memory containing code that, when executed, causes the one or more processors to control the first device to receive, from a second device, an indication associated with a handover of a session to the first device, wherein the session is between the second device and a third device, receive information from the second device for coordinating handover of the session to the first device, and, continue the session with the third device by taking the place of the second device in the session according to the information. The first device may receive the information from the second device over a short range interface and continue the session with the third device over a Wi-Fi channel. The information received from the second device may include a access ID used by the second device in the session between the second device and a third device, and the first device may continue the session with the third device in place of the second device by using the access ID. The access ID may comprise a random access ID generated at the second device. The code may further cause the one or more processors to control the first device to send a handover acceptance to the second device in response the indication. The information received from the second device may include timing information that indicates timing for use of the access ID at the first device during handover.

The disclosed embodiments further include a first device comprising one or more processors, and memory in communication with the processor, the memory containing code that, when executed, causes the one or more processors to control the first device to configure a session with a second device using a selected access ID, determine that a handover of the session from the second device to a third device is to take place, receive and coordinate session communications sent from both the second and third devices during handover, wherein both of the second and third device use the selected access ID, and, continue the session with the third device using the selected access ID, after the second device leaves the session. The first device may comprise a Wi-Fi access point and the session with the second device may be configured over a Wi-Fi channel. The first device may determine that a handover of the session from the second device to a third device is to take place by receiving, from the second device, an indication that a handover of the session from the second device to the third device is to take place. The code may cause the one or more processors to determine that a handover of the session from the second device to a third device is to take place by controlling the first device to receive, from the third device a communication using the selected access ID used by the second device, and, determine, in response to receiving the selected access ID from both the second and third device, that the handover is to take place. The first device may determine, in response to receiving the selected access ID from both the second and third device that the handover is to take place by determining, in response to receiving the selected access ID from both the second and third device, the selected access ID is an access ID designated for handover. The first device may initiate the session with the second device by sending the selected access ID to the second device during initiation of the session.

Although the subject matter has been described in language specific to structural features and/or methodological acts, it is to be understood that the subject matter defined in the appended claims is not necessarily limited to the specific features or acts described above. Rather, the specific features and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operation may be combined with or, be replaced by, my suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modification a falling within the scope of the appended claims.

What is claimed is:

1. A first device comprising:
one or more processors, and memory in communication with the one or more processors, the memory comprising code that, when executed, causes the one or more processors to control the first device to:
configure a session with a second device using an access ID;
determine that a trigger event has occurred; and,
initiate, in response to the trigger event occurring, communications with a third device to hand over the session with the second device to the third device.

2. The first device of claim 1, wherein the communications initiated with the third device include sending of the access ID to the third device.

3. The first device of claim 1, wherein the code is further executable to cause the one or more processors to control the first device to randomly generate the access ID.

4. The first device of claim 1, wherein the code is further executable to cause the one or more processors to control the first device to receive the access ID from the second device.

5. The first device of claim 1, wherein the first device configures the session with the second device over a Wi-Fi channel and initiates the communications with the third device over a short range interface.

6. The first device of claim 1, wherein the first device further comprises a user interface, in communication with the one or more processors, and the first device determines that the trigger event has occurred by receiving input at the user interface indicating that a handover to the third device is to occur.

7. The first device of claim 1, wherein the first device initiates the communications with the third device to hand over the session with the second device by exchanging information including timing information with the third device, wherein the timing information indicates timing for we of the access ID at both of the first and third device during handover.

8. The first device of claim 1, wherein the access ID is a Wi-Fi media access control ID.

9. The first device of claim 1, wherein the code is further executable to cause the one or more processors to control the first device to continue to receive transmissions for the session from the second device after the session is handed over to the third device.

10. The first device of claim 1, wherein the first device determines that the trigger event has occurred by receiving a trigger signal from a fourth device.

11. A first device comprising
one or more processors, and memory in communication with the one or more processors, the memory comprising code that, when executed, causes the one or more processors to control the first device to:
receive, from a second device, a indication associated with a handover of a session to the first device, wherein the session is between the second device and a third device;
receive information from the second device for coordinating handover of the session to the first device; and,
continue the session with the third device by taking the place of the second device in the session according to the information.

12. The first device of claim 11, wherein the first device receives the information from the second device over a short range interface and continues the session with the third device over a Wi-Fi channel.

13. The first device of claim 11, wherein the information received from the second device includes an access ID used by the second device in the session between the second device and the third device, and the first device continues the session with the third device in place of the second device by using the access ID.

14. The first device of claim 11, wherein the access ID comprises a random access ID generated at the second device.

15. The first device of claim 11, wherein the code further causes the one or more processors to control the first device to send a handover acceptance to the second device in response to the indication.

16. The first device of claim 11, wherein the information received from the second device includes timing information that indicates timing for use of the access ID at the first device during handover.

17. A first device comprising:
one or more processors, and memory in communication with the processor, the memory comprising code that, when executed, causes the one or more processors to control the first device to:
configure a session with a second device using a selected access ID;
determine that a handover of the session from the second device to a third device is to take place;
receive and coordinate session communications sent from both the second and third devices during handover, wherein both the second and third device use the selected access ID; and,
continue the session with the third device using the selected access ID, after the second device leaves the session.

18. The first device of claim 17, wherein the first device comprises a Wi-Fi access point and the session with the second device is configured over a Wi-Fi channel.

19. The first device of claim 17, wherein the first device determines that the handover of the session from the second device to the third device is to take place by receiving, from the second device, an indication that a handover of the session from the second device to the third device is to take place.

20. The first device of claim 17, wherein the first device determines that the handover of the session from the second device to the third device is to take place by receiving, from the third device, a communication using the selected access ID used by the second device; and, determining, in response to receiving the selected access ID from both the second and third device, that the handover is to take place.

21. The first device of claim 20, wherein the determining that the handover is to take place comprises determining that the selected access ID is an access ID designated for handover.

22. The first device of claim 21, wherein the first device initiates the session with the second device by sending the selected access ID to the second device during initiation of the session.
